(19) United States
(12) Patent Application Publication
(10) Pub. No.: US 2010/0052861 A1
(43) Pub. Date: Mar. 4, 2010

(54) SIMULATING DEVICE, SIMULATING METHOD AND RECORDING MEDIUM

(75) Inventors: Atsuo Hara, Fukuoka (JP); Takashi Yamagajo, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/552,824

(22) Filed: Sep. 2, 2009

(30) Foreign Application Priority Data
Sep. 4, 2008 (JP) 2008-227519

(51) Int. Cl. H04Q 5/22; G06G 7/62

(52) U.S. Cl. 340/10.1; 703/13

(57) ABSTRACT

The simulating device and method that evaluates the intensity of radio waves including estimating a received power of a radio wave reaching an antenna of a radio tag having an IC chip connected with the antenna, calculating an impedance matching coefficient to use for matching an impedance of the antenna of the radio tag with an impedance of the IC chip of the radio tag, and adjusting the received power estimated with the use of the impedance matching coefficient calculated.

### CROSS-REFERENCE TO RELATED APPLICATIONS

This application is based upon and claims the benefit of priority of the prior Japanese Patent Application No.2008-227519, filed on Sep. 4, 2008, the entire contents of which are incorporated herein by reference.

### FIELD

The present embodiment(s) relate to a recording medium having a simulating program, a simulating device and a simulating method of evaluating the intensity of radio waves received by a radio tag.

In particular, the embodiment(s) relate to a recording medium storing a simulating program, a simulating device and a simulating method capable of evaluating propagation characteristics of a radio wave with respect to an RFID (Radio Frequency Identification) tag with high accuracy.

### BACKGROUND

Nowadays, RFID tags (also called “radio tags”) are being widely used. In particular, a passive RFID tag into which no battery is built communicates with a reader/writer using weak radio waves and hence is liable to be influenced by the state of radio waves used. Thus, a passive RFID tag is hard to exhibit the performance specified, depending on the environment surrounding the tag. Therefore, when a system uses passive RFID tags, it is important to evaluate in advance the radio wave characteristics of the RFID tag in an environment in which the tag is to be actually used.

As a technique for evaluating the radio wave characteristics of the RFID tag, attention is being paid to a ray-tracing method. The ray-tracing method is a technique for estimating the propagation characteristics of a light ray by calculating a path along which a light ray emitted from a transmission point is repeatedly reflected by, diffracted by, and transmitted through surrounding structures, to finally reach a reception point. The ray-tracing method makes it also possible to estimate the radio wave propagation characteristics by regarding the radio wave as a light ray. A typical moment method of obtaining the radio wave propagation characteristics is a technique which has been used to evaluate the radio wave propagation characteristics and a highly accurate evaluation result may be obtained by using this method. However, a large number of calculations are needed in this method. On the other hand, in the ray-tracing method, only a relatively small number of arithmetic operations are needed.

As a ray-tracing method has been proposed, that is described in a treatise entitled “Reading Rate Simulator for Increasing Efficiency of Design Work Upon Introduction of UHF Band RFID (RADIOSCAPE-RFID)” by Hirohito Sugawara and Takashi Ono in “NEC Technology” (2006, Vol. 59, pp 112 to 115) issued by Nihon Denki K. K.

### SUMMARY

A simulating method that evaluates the intensity of a radio wave, including estimating a received power of a radio wave reaching an antenna of a radio tag including an IC chip connected with the antenna calculating part calculating an impedance matching coefficient used to match an impedance of the antenna of the radio tag with an impedance of the IC chip of the radio tag and adjusting the received power estimated with the use of the impedance matching coefficient calculated.

It is an aspect of the embodiments discussed herein to provide a simulating device. The simulating device that evaluates the intensity of radio waves includes a ray-tracing part estimating a received power of a radio wave reaching an antenna of a radio tag including an IC chip connected with the antenna, a matching coefficient calculating part calculating an impedance matching coefficient used to match an impedance of the antenna of the radio tag with an impedance of the IC chip of the radio tag, and an adjusting part adjusting the received power estimated in the ray-tracing part with the use of the impedance matching coefficient calculated in the matching coefficient calculating part.

The object and advantages of embodiment(s) discussed herein will be realized and attained by means of elements and combinations particularly pointed out in the claims.

It is to be understood that both the foregoing general description and the following detailed and the following detailed description are exemplary and only are not restrictive exemplary explanatory are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a functional block diagram depicting an example of a configuration of a simulating device according to an embodiment;

FIG. 2 is a diagram depicting an example of a model of impedance matching of an RFID tag;

FIG. 3 is a diagram depicting an example of a model of impedance matching obtained when an IC chip has been taken into consideration;

FIG. 4 is a diagram depicting an example of a method of evaluating the received power;

FIG. 5 is a graph depicting an example of an evaluation result obtained when an impedance matching coefficient τ has not been taken into consideration;

FIG. 6 is a graph depicting an example of an evaluation result obtained when the impedance matching coefficient τ has been taken into consideration;

FIG. 7 is a diagram depicting a received power evaluating method adopted when a plurality of RFID tags are arrayed;

FIG. 8 is a graph depicting an example of an evaluation result obtained when reception antenna radiation pattern data of all the RFID tags has been input;

FIG. 9 is a graph depicting an example of an evaluation result obtained when the reception antenna radiation pattern data of the RFID tags disposed at the both ends and the center of the array has been input;

FIG. 10 is a diagram depicting an example of an evaluation result;

FIG. 11 is an operation chart depicting an example of processing procedures executed using a simulating device; and

FIG. 12 is a functional block diagram depicting an example of a computer executing a simulating program.

### DETAILED DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

A typical ray-tracing method is a technique for calculating a geometric locus of a radio wave and hence has a problem such that propagation characteristics of a radio wave with respect to an RFID tag is hard to be evaluated with full accuracy. For example, a transfer loss is induced due to impedance mismatching of an antenna used for transmission and reception of radio waves on an RFID tag. However, the above-mentioned characteristic has not been taken into consideration in the typical ray-tracing method.

The technique disclosed in an embodiment(s) of the present application has been made in order to solve the problems intrinsic to the above mentioned related art. Accordingly, an object of an embodiment is to provide a recording medium storing a simulating program, a simulating device and a simulating method capable of evaluating propagation characteristics of a radio wave with respect to a radio tag, in particular, an RFID tag with accuracy.

Next, preferred embodiments of the simulating program, the simulating device and the simulating method disclosed by the present application will be described in detail with reference to the accompanying drawings. In the following examples, mainly, the case where propagation characteristics obtained when a passive RFID tag receives a radio wave are evaluated will be described. The technique disclosed in the present application also makes it possible to evaluate the propagation characteristics obtained when a reader/writer receives the radio wave transmitted from the RFID tag.

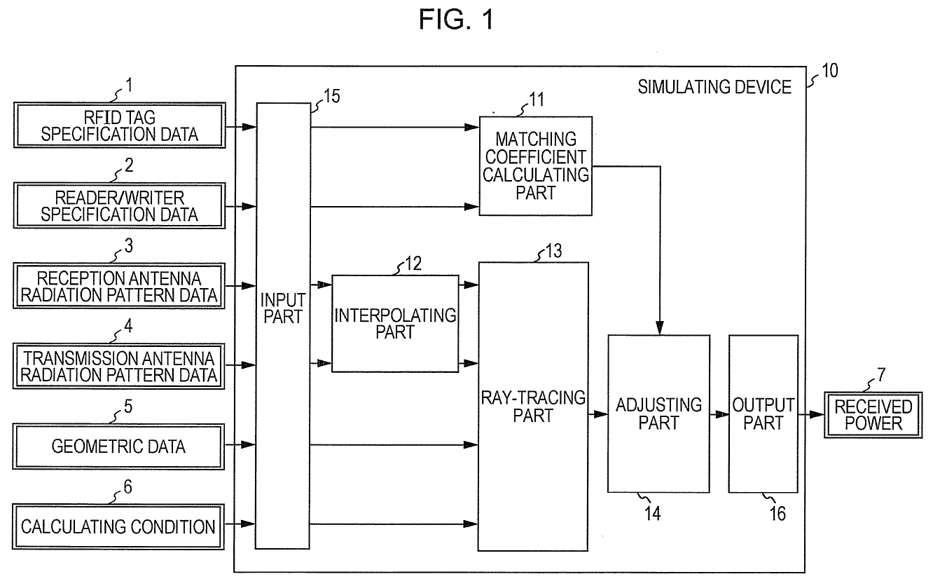

First, a configuration of a simulating device 10 according to an embodiment of the present application is described. FIG. 1 is a functional block diagram depicting an example of the configuration of the simulating device 10. As depicted in FIG. 1, the simulating device 10 includes a matching coefficient calculating part 11, an interpolating part 12, a ray-tracing part 13, an adjusting part 14, an input part 15 and an output part 16.

The input part 15 accepts one or more input data, for example, RFID tag specification data 1, reader/writer specification data 2, reception antenna radiation pattern data 3, transmission antenna radiation pattern data 4, geometric data, calculating conditions 6 and etc. The output part 16 outputs a received power 7 calculated (estimated) using the ray-tracing part 13 and adjusted using the adjusting part 14 as a simulation result. While specific types of input data is provided to describe data input, no limitation is intended thereby. For example, any one or combination of data may be input via the input part 15.

The matching coefficient calculating part 11 calculates an impedance matching coefficient for an antenna and an IC (Integrated Circuit) chip attached to an RFID tag. The impedance matching coefficient is a coefficient indicative of a degree to which the impedances of the antenna and the IC chip match each other, in other words, indicative of the efficiency with which the radio wave that the RFID tag has received from a reader/writer is converted into electricity.

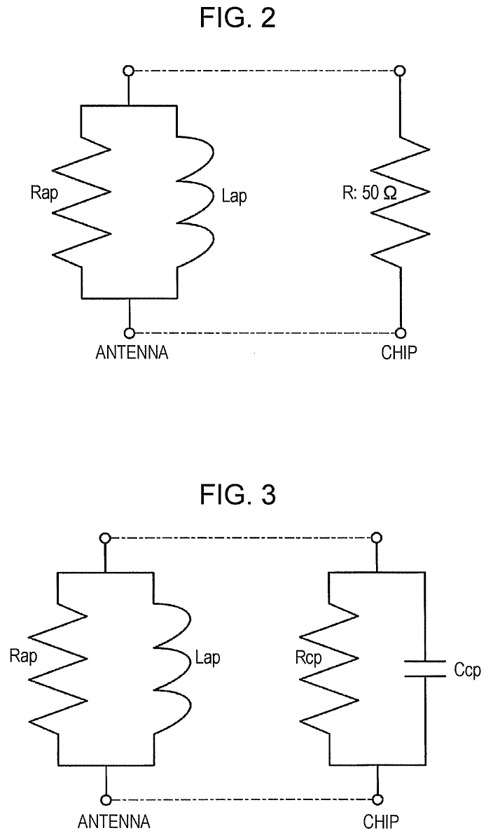

In general, in the case that impedance matching of the RFID tag is considered, a characteristic impedance of 50Ω on a coaxial line is used as the impedance of the IC chip on the basis of a model depicted in FIG. 2. However, in reality, the impedance of the IC chip is different from the impedance of 50Ω on the coaxial line as depicted in FIG. 3.

Thus, the matching coefficient calculating part 11 calculates the impedance matching coefficient τ for the antenna and the IC chip of the RFID tag using the following numerical formulas 1 to 3.

$$\begin{matrix}Numerical Formula 1 & \\ {X}_{c} = \frac{1}{j ω Ccp} & ( 1 ) \\ Numerical Formula 2 & \\ {X}_{A} = j ω Lap & ( 2 ) \\ Numerical Formula 3 & \\ τ = \frac{4 {R}_{A} {R}_{C}}{{( {R}_{A} + {R}_{C} )}^{2} + {( {X}_{A} + {X}_{C} )}^{2}} & ( 3 )\end{matrix}$$

Here, j is an imaginary unit, ω is an angular velocity of AC, Ccp is a chip capacity component of the IC chip, Lap is an inductance component of the antenna, R_{A} is a radiation resistance of the antenna and Rc is a chip resistance of the IC chip.

The impedance matching coefficient τ calculated in the above-mentioned manner is used in a process of adjusting the received power performed using the adjusting part 14. By adjusting the received power on the basis of the impedance matching coefficient τ, calculation of the accurate received power on which the characteristics of the RFID tag have been reflected may be realized.

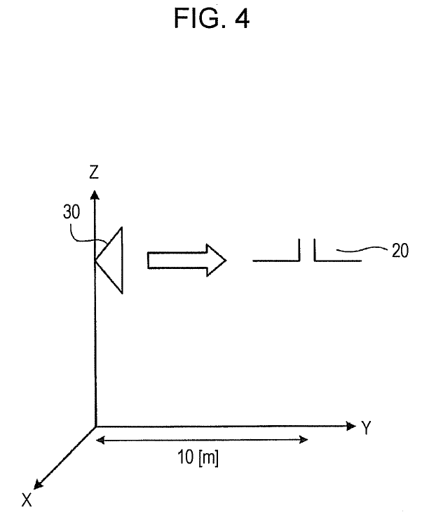

Here, FIG. 4 depicts an example in which a distance between an RFID tag 20 and a reader/writer antenna 30 has been changed by 10 m each time and the received power of the RFID tag 20 over each distance has been calculated by a ray-tracing method and a moment method. The moment method is a technique which has been used to date for evaluation of propagation characteristics of a radio wave. Although a highly accurate evaluation result is obtained by the moment method, an extremely large number of calculations are needed in this method.

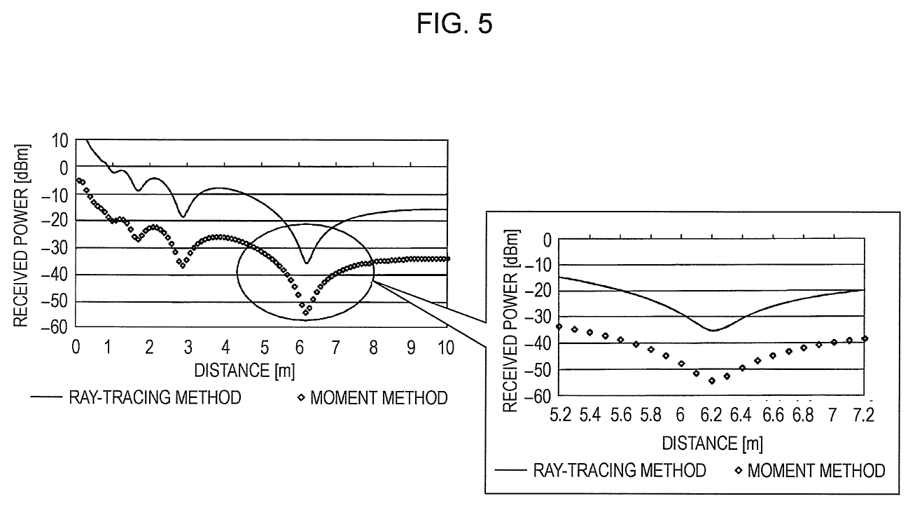

FIG. 5 is a graph depicting an example of an evaluation result obtained when the impedance matching coefficient τ has not been taken into consideration. As depicted in FIG. 5, when the impedance matching coefficient τ has not been taken into consideration, the evaluation result obtained by the ray-tracing method is different from that obtained by the moment method.

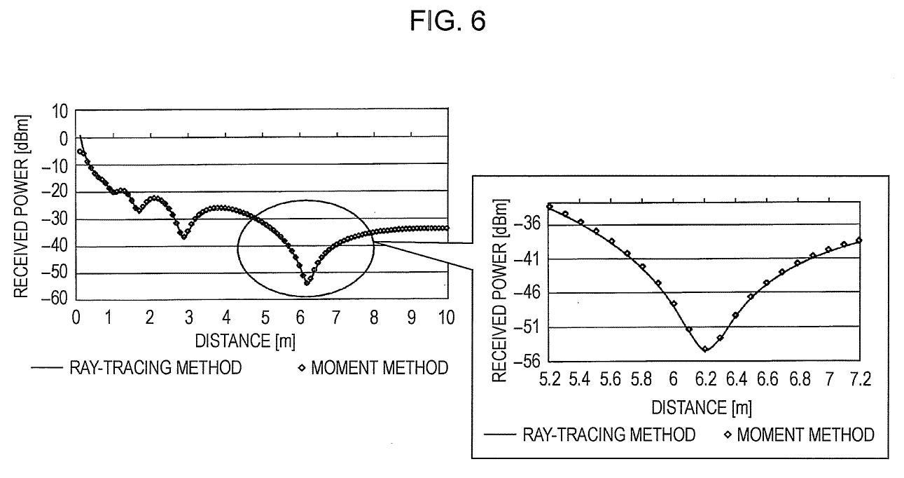

FIG. 6 is a graph depicting an example of an evaluation result obtained when the impedance matching coefficient τ has been taken into consideration. As depicted in FIG. 6, in the case that the impedance matching coefficient τ has been taken into consideration, the evaluation result obtained by the ray-tracing method almost coincides with that obtained by the moment method. Although the ray-tracing method needs a smaller number of calculations than the moment method, calculation accuracy almost equal to that attained by the moment method can be attained by the ray-tracing method by taking the impedance matching coefficient τ into consideration as above-mentioned.

Incidentally, in the case that propagation characteristics obtained when the radio wave transmitted from an RFID tag is received by a reader/writer are to be evaluated, the matching coefficient calculating part 11 calculates an impedance matching coefficient for an antenna and a cable of the reader/writer on the basis of the input reader/writer specification data 2.

The interpolating part 12 (FIG. 1) interpolates the input reception antenna radiation pattern data 3. The reception antenna radiation pattern data 3 is complex number data indicating the intensity of a radio wave received by the antenna in accordance with a radio wave incidence direction and obtained by a moment method, an FDTD method and a finite element method. The input reception antenna radiation pattern data 3 is used to calculate (estimate) the intensity of the radio wave per path using the ray-tracing part 13.

Generally, when a plurality of RFID tags are disposed, the reception antenna radiation pattern 3 is preferably prepared for each RFID tag with consideration of a number of tags and the interval between the tags. The reason for this lies in the fact that since the antenna of the RFID tag is made of metal, in the case that the RFID tags are disposed adjacent to one another, a coupling phenomenon occurs between the adjacent antennas and hence the antenna radiation pattern is changed accordingly.

However, when each RFID tag is affixed to a corresponding small-sized product and many products with the RFID tags affixed thereto are contained in a corrugated card-board box, it sometimes occurs that one hundred or more RFID tags are arrayed at narrow intervals. In this situation, it takes much time and labor to prepare the reception antenna radiation pattern data 3 for each RFID tag.

Thus, when the reception antenna radiation pattern data 3 of some RFID tags is input when a plurality of RFID tags are arrayed, the interpolating part 12 generates the reception antenna radiation pattern data 3 of the remaining RFID tags by executing an interpolating process.

Specifically, when there exists an RFID tag into which the reception antenna radiation pattern data 3 is not input, the interpolating part 12 selects its surrounding RFID tags into which the reception antenna radiation pattern data 3 is input. Then, the interpolating part 12 performs the interpolating process on the reception antenna radiation pattern data 3 of the selected RFID tags in each radio wave incident direction in accordance with distances among one selected RFID tag and the RFID tag to be interpolated and the other selected RFID tag to generate interpolation data for the reception antenna radiation pattern data 3. Incidentally, as for an interpolation system, either a linear interpolation system or a multi-dimensional interpolation system may be adopted.

For example, when a plurality of RFID tags are arrayed, if the reception antenna radiation pattern data 3 of the RFID tags disposed at both the ends and at the center of the array is input, a fully accurate evaluation result can be obtained by performing the interpolating process using the interpolating part 12.

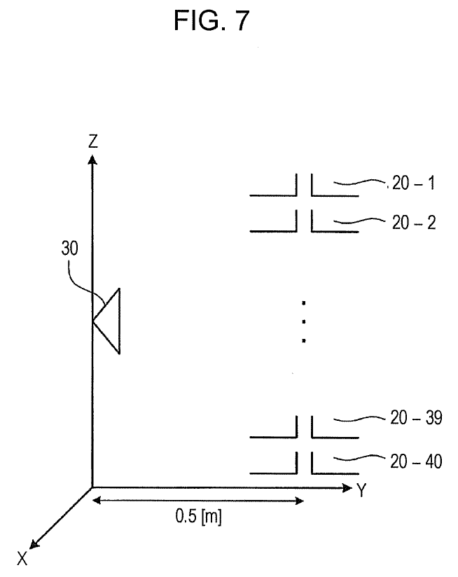

In relation to the above, FIG. 7 depicts a calculation example of the received power of each RFID tag when forty RFID tags 20 are arrayed and a reader/writer antenna 30 is disposed at a position 0.5 m from the forty RFID tags 20.

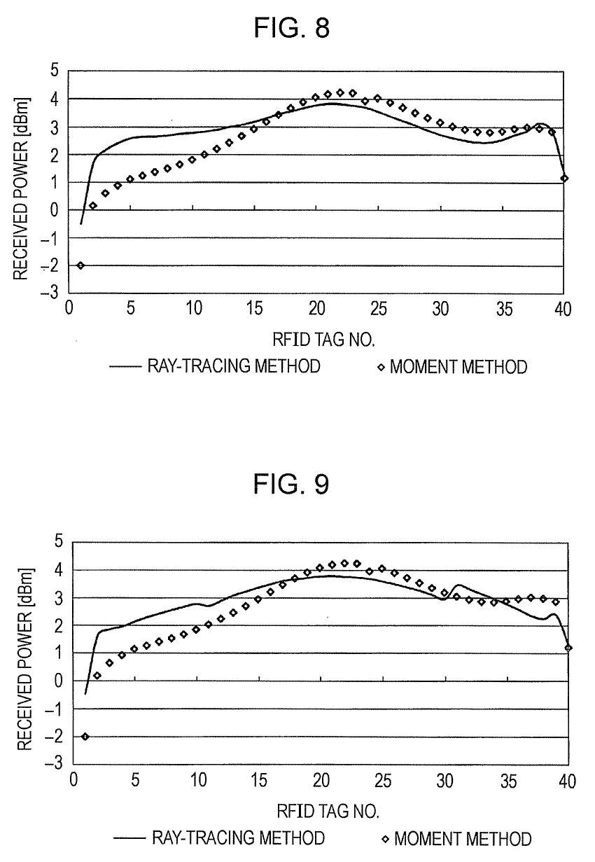

FIG. 8 is a graph depicting an example of a calculation result obtained when the reception antenna radiation pattern data 3 of all the RFID tags 20 has been input. The graph illustrates the received power of each RFID tag which has been calculated by a ray-tracing method by inputting the reception antenna radiation pattern data 3 of all the RFID tags 20 together with the received power of each RFID tag calculated by a moment method. As depicted in the graph, the calculation result obtained by the ray-tracing method almost coincides with the calculation result obtained by the moment method.

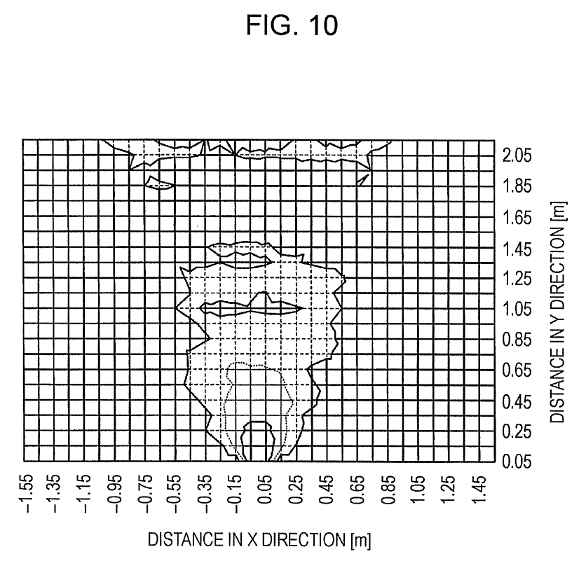

FIG. 9 is a graph depicting an example of a calculation result obtained when only the reception antenna radiation pattern data 3 of the RFID tags 20 disposed at both the ends and the center of the array has been input. FIG. 9 illustrates the received power of each RFID tag which has been calculated by the ray-tracing method by generating the reception antenna radiation pattern data 3 of the RFID tags 20 other than the tags disposed at both the ends and the center of the array by performing an interpolating process together with the received power of each RFID tag obtained by the moment method. As depicted in FIG. 9, even if only the reception antenna radiation pattern data 3 of the RFID tags 20 disposed at both the ends and at the center of the array has been input, the calculation accuracy equivalent to that of the calculation result obtained by the moment method may be obtained.

Incidentally, when the propagation characteristics obtained in the case that the radio wave transmitted from an RFID tag is received by a reader/writer is to be evaluated, the interpolating part 12 generates the transmission antenna radiation patter data 4 which is not input into the tag by performing an interpolating process. The transmission antenna radiation pattern data 4 is complex number data indicating the intensity of a radio wave transmitted from an antenna in each radio wave incidence direction and is obtained by a moment method, an FDTD method and a finite element method. The transmission antenna pattern data 4 is used to calculate (estimate) the intensity of each radio wave along each path using the ray-tracing part 13 and originally may be preferably prepared for each RFID tag which transmits the radio wave.

Description will be made returning to FIG. 1. In FIG. 1, the ray-tracing part 13 evaluates the radio wave propagation characteristics by using the ray-tracing method. As a value calculated (estimated) using the ray-tracing part 13, for example, a value indicative of the received power of a radio wave received by the RFID tag is given. The ray-tracing part 13 uses the reception antenna radiation pattern data 3, the transmission antenna radiation pattern data 4, the geometric data 5 and the calculating conditions 6 to evaluate the radio wave propagation characteristics. The reception antenna radiation pattern data 3 and the transmission antenna radiation pattern data 4 are used as part of information used to evaluate what numbers of radio waves which have been regarded as light rays reach an RFID tag.

The geometric data 5 includes physical information relating to an environment in which an RFID tag is used and includes a form, a size and a quality of a material of a space where a reader/writer is installed, a position and a direction in which the reader/writer is installed, a number of RFID tags and a position and a packaged form of each RFID tag. The calculation conditions 6 include various calculation conditions such as the frequency and the like of a radio wave used.

The adjusting part 14 performs an adjusting process on a calculation (estimation) result obtained using the ray-tracing part 13. Specifically, the adjusting part 14 multiplies the received power of each RFID tag calculated (estimated) using the ray-tracing part 13 and the impedance matching coefficient τ calculated using the matching coefficient calculating part 11 to calculate the received power 7 of each RFID tag. The received power 7 calculated using the adjusting part 14 is output as an evaluation result.

FIG. 10 is a diagram depicting an example of an evaluation result. In the example depicted in FIG. 10, a readable/writable range of each RFID tag is indicated on the basis of the received power so calculated.

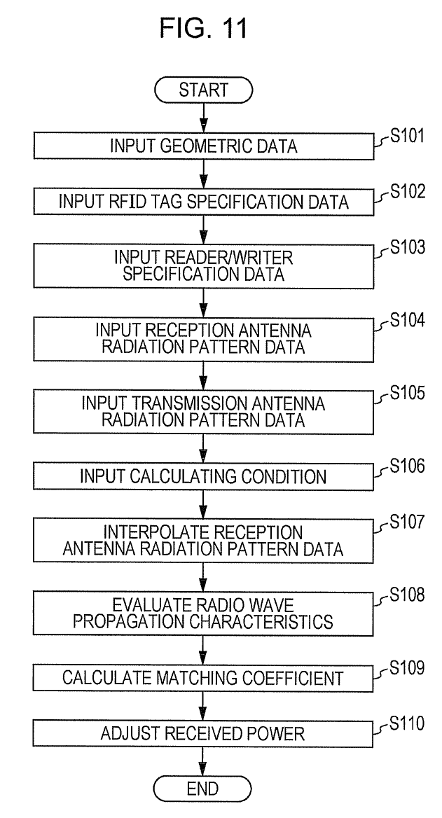

Next, procedure(s) of a process executed using the simulating device 10 depicted in FIG. 1 is described. FIG. 11 is an operation chart depicting an example of the procedures of the process executed using the simulating device 10. As depicted in FIG. 11, the simulating device 10 accepts input of the geometric data 5 (at operation S101), accepts input of the RFID tag specification data 1 (at operation S102) and then accepts input of the reader/writer specification data 2 (at operation S103).

In addition, the simulating device 10 accepts input of the reception antenna radiation pattern data 3 (at operation S104), accepts input of the transmission antenna radiation pattern data 4 (at operation S105) and then accepts input of the calculation conditions 6 (at operation S106). Then, when there exist RFID tags into which the reception antenna radiation pattern data 3 is not input after the above mentioned various pieces of data have been input, the interpolating part 12 performs an interpolating process to generate the reception antenna radiation pattern data 3 of the above mentioned RFID tags (at operation S107).

Next, the ray-tracing part 13 evaluates the radio wave propagation characteristics (at operation S108) and the matching coefficient calculating part 11 calculates the impedance matching coefficient τ (at operation S109). Then, the adjusting part 14 adjusts the received power, that is, the calculation (estimation) result obtained using the ray-tracing part 13 with the use of the impedance matching coefficient τ to output the received power 7 (at operation S110).

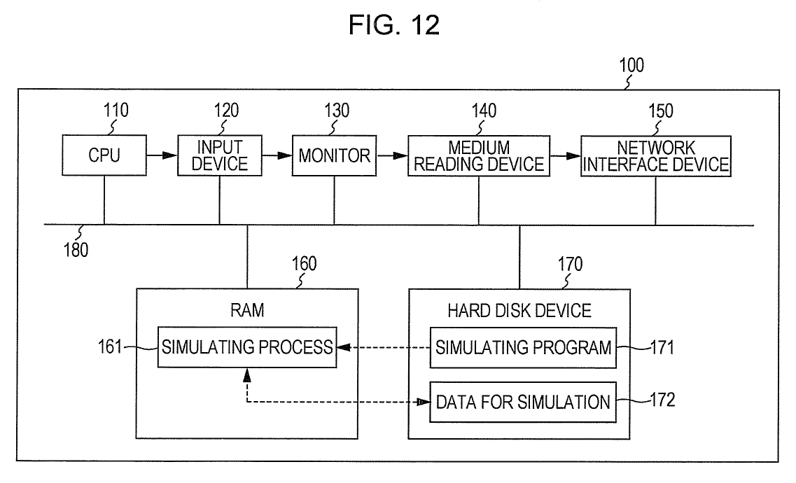

Incidentally, the configuration which the simulating device 10 includes according to an embodiment of the present application depicted in FIG. 1 may be altered in a variety of ways without departing from the scope and the gist of an embodiment. For example, a function equal to that of the simulating device 10 may be realized by implementing the function of the simulating device 10 as software and executing the software using a computer. Next, an example of a computer used to execute a simulation program 171 (FIG. 12) into which the function of the simulating device 10 has been implemented as software will be depicted.

FIG. 12 is a functional block diagram depicting an example of a computer 100 that executes the simulation program 171. The computer 100 includes a CPU (Central Processing Unit) 110 that executes various operational processing, an input device 120 that accepts input of data including from a user, a monitor 130 that displays various pieces of information, a medium reading device 140 that reads out a program from a recording medium, a network interface device 150 that transmits data to and receives data from other computers via a network, a RAM (Random Access Memory) 160 that temporarily stores various pieces of information, and a hard disk device 170 which is connectable one another via a bus 180.

The simulation program 171 having the function equal to that of the simulating device 10 depicted in FIG. 1 and simulation data 172 corresponding to various pieces of data input into the simulating device depicted in FIG. 1 are stored in the hard disk device 170. As an alternative, the simulation data 172 may be appropriately distributed and stored in other computers connected with the simulating device via a network.

In the example depicted in FIG. 12, the CPU 110 reads out the simulation program 171 from within the hard disk device 170 and expands the program in the RAM 160. As a result, the simulation program 171 comes to function as a simulating process 161. Then, the simulating process 161 functions to appropriately expand information read out from the simulation data 172 in an area which has been allocated to the process itself in the RAM 160 and to make the computer execute various data processing on the basis of the data so expanded.

Incidentally, the simulation program 171 need not necessarily be stored in the hard disk device 170 and the program may be stored in a storage medium such as a CD-ROM such that the computer 100 reads out the program from within the storage medium to execute processes stored therein. In addition, the program may be stored in other computers (or servers) which are connected with the computer 100 via a public line, Internet, LAN (Local Area Network) or WAN (Wide Area Network) such that the computer 100 reads out the program from the above mentioned computers or servers to execute processes stored therein.

Further, according to an aspect of the embodiments, any combinations of the described features, functions and/or operations can be provided.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

The embodiments can be implemented in computing hardware (computing apparatus) and/or software, such as (in a non-limiting example) any computer that can store, retrieve, process and/or output data and/or communicate with other computers. The results produced can be displayed on a display of the computing hardware. A program/software implementing the embodiments may be recorded on computer-readable media comprising computer-readable recording media. The program/software implementing the embodiments may also be transmitted over transmission communication media. Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. An example of communication media includes a carrier-wave signal.

Further, according to an aspect of the embodiments, any combinations of the described features, functions and/or operations can be provided.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention, the scope of which is defined in the claims and their equivalents.

1. A computer-readable recording medium storing a program for causing a computer to function as a simulation device, the program causing the computer to execute operations, comprising:
estimating received power of a radio wave reaching to an antenna of a radio tag including an IC chip connected with the antenna;
calculating an impedance matching coefficient to use for matching an impedance of the antenna of the radio tag with an impedance of the IC chip of the radio tag; and
adjusting the received power estimated in the estimating, based on the calculated impedance matching coefficient.

2. The computer-readable recording medium according to claim 1, wherein the estimating estimates the received power radiation pattern data of the radio wave inputted into each radio tag.

3. The computer-readable recording medium according to claim 2, wherein when there exists a radio tag into which the radiation pattern data is not inputted, generating the radiation pattern data of the radio tag concerned by the interpolating on the radiation pattern data of the other radio tags.

4. A simulating device that evaluates the intensity of a radio wave, the simulating device comprising:
a ray-tracing part estimating a received power of a radio wave reaching the antenna of a radio tag including an IC chip connected with the antenna;
a matching coefficient calculating part calculating an impedance matching coefficient to use for matching an impedance of the antenna of the radio tag with an impedance of the IC chip of the radio tag; and
an adjusting part adjusting the received power estimated in the ray-tracing part with the use of the impedance matching coefficient calculated in the matching coefficient calculating part.

5. The simulating device according to claim 4, further comprising:
an input part which inputs at least the impedance matching coefficient to use for matching the impedance of the antenna of the radio tag and the impedance of the IC chip of the radio tag as specification information of the radio tag; and
an output part outputting the received power adjusted in the adjusting part as a simulation result.

6. The simulating device according to claim 4, wherein
the ray-tracing part calculates the received power by using radiation pattern data of a radio wave input into each radio tag.

7. The simulating device according to claim 6, further comprising:
an interpolating part generating the radiation pattern data of a radio tag concerned by performing an interpolating process on the radiation pattern data of the other radio tag when there exists a radio tag into which the radiation pattern data is not input.

8. A simulating method that causes a computer to function as a simulating device, comprising:
executing a first calculating the received power of a radio wave reaching the antenna of the radio tag including an IC chip connected with the antenna;
executing a second calculating an impedance matching coefficient used to match an impedance of the antenna of the radio tag with an impedance of the IC chip of the radio tag with each other; and
adjusting the received power result calculated in the first calculating with use of the impedance matching coefficient calculated in the second calculating.

9. The simulating method according to claim 8, wherein in the first calculating, radiation pattern data of an electric wave input into each radio tag is used to calculate the received power.

10. The simulating method according to claim 9, further comprising:
generating the radiation pattern data of a radio tag concerned by performing an interpolating process on the radiation pattern data of the other radio tag using the simulating device when there exists a radio tag into which the radiation pattern data is not input in the interpolating.
